(19) United States
(12) Patent Application Publication
(10) Pub. No.: US 2026/0195248 A1
(43) Pub. Date: Jul. 9, 2026

(54) FEATURE SIMULATION TO ENHANCE END-TO-END SOFTWARE APPLICATION TESTING

(71) Applicant: Capital One Services, LLC, McLean, VA (US)

(72) Inventors: Carel de BRUYN, Prosper, TX (US); Alit PONKAEW, Plano, TX (US); David DUONG, Plano, TX (US)

(73) Assignee: Capital One Services, LLC, McLean, VA (US)

(21) Appl. No.: 19/014,667

(22) Filed: Jan. 9, 2025

(51) Int. Cl. G06F 11/3668; G06F 11/362

(52) U.S. Cl. CPC G06F 11/3688; G06F 11/3636; G06F 11/3696

(57) ABSTRACT

Systems and methods for implementing a feature simulation framework in end-to-end testing of software applications. In some aspects, the system receives a first test case for testing a first target feature of a software application. The system retrieves a feature definition for the first target feature, including one or more inputs and one or more outputs, and a dependency chain for the first target feature. The dependency chain includes other target features and an execution order. Based on one or more input values from the first test case, the system invokes one or more external services to execute the first target feature. The system simulates other target features in the dependency chain for the first target feature. The system compiles output values for one or more outputs for the first test case for validation against reference output values to determine whether the first target feature is implemented correctly.

### SUMMARY

The systems and methods described herein address the complexities and inefficiencies inherent in traditional software testing methodologies. The conventional approach to end-to-end software application testing typically involves running comprehensive test cases that assess the functionality and performance of various interconnected features. This method, however, is often fraught with challenges, such as the need for real-time access to all dependent components and APIs, which can be impractical and time-consuming, particularly in non-production environments. The core problem tackled by the systems and methods described herein is the cumbersome nature of testing interdependent features within a software application while ensuring that these features and their associated dependency APIs behave as expected.

Conventional methods inadequately manage the orchestration and validation of numerous features simultaneously, leading to potential inaccuracies in test results and inefficiencies in test case execution. The systems and methods described herein offer an improved technical solution by introducing a sophisticated feature simulation framework designed to virtualize dependencies and streamline the testing process. At its essence, the systems and methods described herein encompass receiving a first test case aimed at evaluating a specific target feature of a software application. Upon receiving the test case, the feature definition, comprising the necessary inputs, outputs, and an execution-dependent chain of related features, is retrieved. This dependency chain outlines other target features and dictates their execution sequencing. Subsequently, one or more external services are invoked based on the input values of the first test case to execute the targeted feature. Concurrently, the simulation framework simulates the other target features within the dependency chain, ensuring all interconnected features are adequately represented and tested within the controlled environment. The output values generated from these simulations are compiled and validated against predefined reference output values to ascertain the correctness of the implementation of the first target feature.

By decoupling the features and virtualizing the dependencies, the systems and methods described herein overcome the limitations of conventional systems, offering a more flexible, extensible, and efficient testing framework. It eliminates the need for real-time access to dependent systems, thereby facilitating more robust and error-resilient testing scenarios. This improves overall software quality and significantly reduces the time and resources typically required for comprehensive end-to-end testing. In this manner, the systems and methods described herein present a novel method for implementing a simulation framework that enhances the efficiency, accuracy, and robustness of end-to-end testing in software applications. By leveraging virtualization and systematic orchestration of feature simulations, it addresses the critical issues faced by conventional testing methodologies and provides a superior solution for modern software development environments.

In some aspects, to address one or more of the technical problems described above, systems and methods are described herein for implementing a feature simulation framework in end-to-end testing of software applications. The system receives one or more test cases for testing a plurality of target features of a software application, including a first test case for a first target feature. The system executes a feature definition function for the plurality of target features. A feature definition is constructed for each target feature, including one or more inputs required for executing the target feature, one or more outputs produced by executing the target feature, and one or more virtualized APIs associated with the target feature. The virtualized APIs simulate responses of dependency APIs. The system simulates the first test case for the first target feature by determining a dependency chain for the first target feature, based on one or more input values from the first test case, invoking one or more external services to execute the first target feature via one or more API calls, simulating one or more user interface interactions, and executing one or more predefined scripts or commands. The dependency chain includes other target features from the plurality of target features, specifies an execution order for target features in the dependency chain, and output from one target feature is forwarded as input for another target feature. The system simulates responses of dependency APIs based on the one or more virtualized APIs associated with the first target feature. The system simulates other target features in the dependency chain for the first target feature. The system compiles output values for one or more outputs for the first test case. The system validates the output values for one or more outputs for the first test case against reference output values to determine whether the output values are within a threshold. Based on a result of validating the output values, the system generates a test result indicating whether the first target feature of the software application is implemented correctly.

Various other aspects, features, and advantages of the disclosure will be apparent through the detailed description and the drawings attached hereto. It is also to be understood that both the foregoing general description and the following detailed description are examples, and not restrictive of the scope of the disclosure. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative environment for implementing a feature simulation framework in end-to-end testing of software applications, in accordance with one or more implementations.

FIG. 2 shows an illustrative example of implementing a feature simulation framework in end-to-end testing of software applications, in accordance with one or more implementations.

FIG. 3 shows an exemplary simulation request payload for a feature simulation framework in end-to-end testing of software applications, in accordance with one or more implementations.

FIG. 4 shows an illustrative architecture for a system for implementing a feature simulation framework in end-to-end testing of software applications, in accordance with one or more implementations.

FIG. 5 shows a flowchart of the operations involved in implementing a feature simulation framework in end-to-end testing of software applications, in accordance with one or more implementations.

### DETAILED DESCRIPTION

In the following description, for the purposes of explanation, numerous specific details are set forth in order to provide a thorough understanding of the implementations of the systems and methods described herein. It will be appreciated, however, by those having skill in the art, that the implementations may be practiced without these specific details or with an equivalent arrangement. In other cases, well-known structures and devices are shown in block diagram form in order to avoid unnecessarily obscuring the implementations.

In some aspects, the systems and methods described herein improve over the conventional approach to software testing by introducing an advanced simulation framework designed to enhance the accuracy and efficiency of end-to-end testing. Traditional methods often struggle with the complexities of testing interdependent features and the necessity of real-time access to all dependent components and APIs, making comprehensive and effective testing laborious and error-prone. The described systems and methods address these challenges by providing a method that virtualizes dependencies and orchestrates the testing process through a comprehensive simulation framework.

For example, consider a test case for a shopping cart on a website, where the features tested include “adding an item to the shopping cart,” “checkout,” and “payment.” Here's how the systems and methods would be applied: First, the system receives a test case for the feature of adding an item to the shopping cart. It retrieves the feature definition, which includes inputs such as item ID and quantity, outputs like confirmation of the item added, and dependencies that may include inventory check APIs. Based on the input values, the system invokes external services to simulate adding the item to the cart and checks the related dependency, such as updating the cart database. For the checkout feature, the system retrieves the feature definition, which includes inputs like the selected items, user details, and delivery options. The simulation framework handles the checkout process, ensuring all cart items are processed for checkout and simulates dependencies like shipping calculation APIs. For the payment feature, the inputs include payment details (e.g., credit card information), and outputs might be payment confirmation and receipt generation. The system simulates processing the payment and handles dependencies such as payment gateway APIs. Once the features have been simulated, the framework compiles the output values of the test case and validates them against the reference values to ensure the correct implementation of each feature.

Conventional systems often require access to live systems and dependencies for comprehensive testing, making the process cumbersome and sometimes unreliable. In contrast, the unique method of decoupling features and virtualizing dependencies described herein allows for more efficient, flexible, and accurate testing. The use of a simulation framework not only simplifies the execution and orchestration of tests but also significantly improves error handling and robustness under varying scenarios. The described systems and methods provide a powerful and sophisticated solution to the inherent problems of traditional software testing methods by facilitating robust, automated, and efficient end-to-end testing through a comprehensive feature simulation framework.

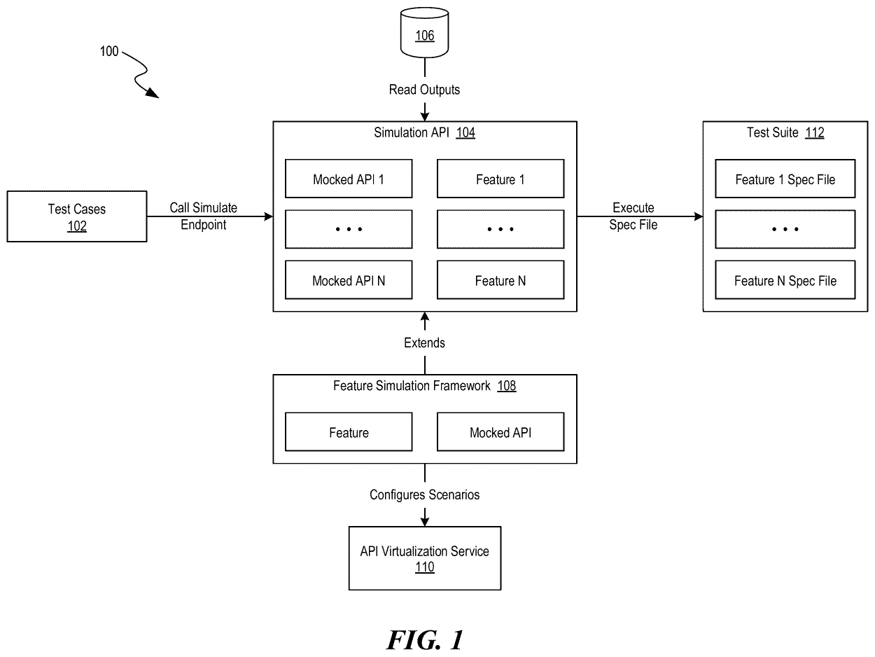

FIG. 1 shows an illustrative environment 100 for implementing a feature simulation framework in end-to-end testing of software applications, in accordance with one or more implementations. Environment 100 may significantly enhance the accuracy and efficiency of software testing by simulating various features and their dependent components in non-production environments. The testing process begins with test cases 102, which are detailed scenarios designed to assess specific functionalities within a software application. For instance, in a shopping cart application, a test case might include steps such as adding an item to the cart, proceeding to checkout, and completing the payment. These test cases are fed into the Simulation API 104, a central component of the framework.

The Simulation API 104 includes mocked APIs and features necessary for executing these test cases. For example, when testing the “Add to Cart” feature, the Simulation API might interact with a mocked inventory check API to determine item availability. In the checkout process, it might simulate shipping calculation APIs, while during payment, it could engage with virtualized payment gateway APIs to mimic various payment scenarios like successful transactions or failures due to insufficient funds. An integral part of this framework may be the ability to read outputs from a database 106. This database stores relevant state information and output values, which are crucial for driving the simulation. When a user adds an item to their cart, the system reads the cart status from the database to decide the next action—such as proceeding to checkout if the item is in stock.

To support these functionalities, the framework incorporates a feature simulation component 108, which in some examples may include a sophisticated Java library or another suitable library. This library may be designed to execute custom features, handle predefined integrations such as API calls and database connections, and manage the execution of comprehensive test suites. For the shopping cart example, this might involve fetching real-time inventory data, interacting with shipping services to calculate delivery costs, or processing test transactions through a simulated payment gateway.

The framework includes dynamic API virtualization capabilities. By integrating with an API virtualization service 110, the system can configure and manage various testing scenarios. For example, it can simulate different responses from the payment gateway, such as handling scenarios where a transaction is declined due to insufficient funds or approved upon successful verification. This dynamic management ensures each feature's behavior is tested under a variety of conditions, enhancing the robustness of the software under test.

Moreover, the Simulation API 104 generates specification files for each feature, which are then passed to a test suite 112 for execution. This test suite may be a comprehensive UI regression testing suite designed to interact with other UI tools. In the context of the shopping cart application, the test suite would automatically execute steps to add items to the cart, perform actions in the checkout process, and simulate payment transactions. These automated tests ensure the application performs consistently and correctly across different scenarios.

Accordingly, the feature simulation framework provides a powerful and sophisticated solution for end-to-end testing of software applications by decoupling features from their live dependencies and virtualizing the testing environment. This allows for more efficient, flexible, and accurate software testing, ultimately leading to higher software quality and reduced development time.

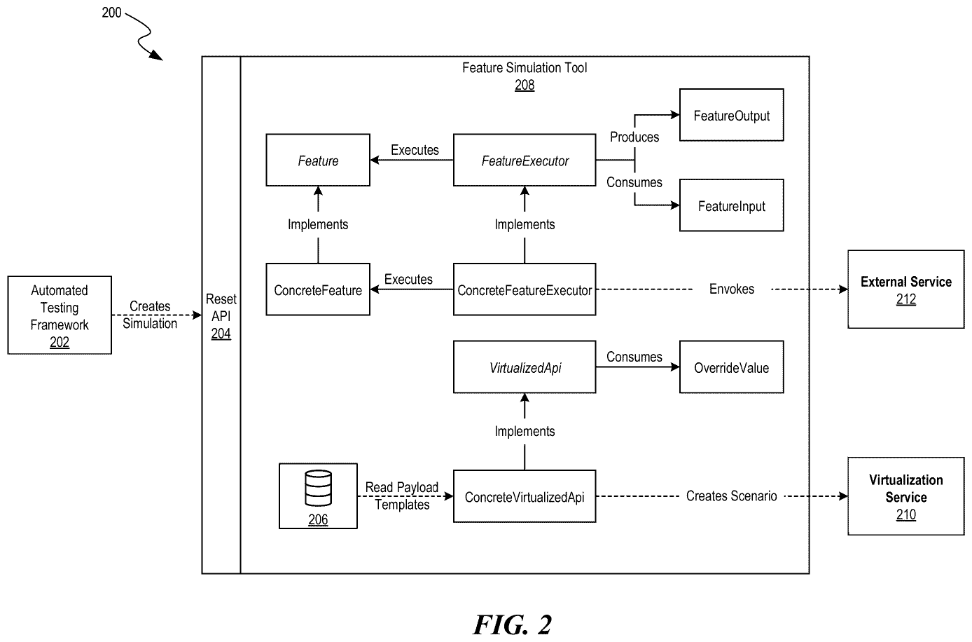

FIG. 2 shows an illustrative example of implementing a feature simulation framework 200 in end-to-end testing of software applications, in accordance with one or more implementations. The process begins with the automated testing framework 202, which is responsible for creating and managing simulation requests. These requests are then passed to a REST API 204, which serves as the entry point to the feature simulation tool 208. This tool is central to the framework, handling various tasks such as managing payload templates and virtualized APIs.

Within the feature simulation tool 208, payload templates are a crucial element that define the structure and contents of simulated API requests and responses. These templates are sourced from a database 206, which stores predefined data formats and values. For example, in a shopping cart application, a payload template might include fields such as {“item_id”: “12345”, “quantity”: 2, “user_id”: “67890”} to simulate adding an item to a user's cart. These payload templates are then passed to a concrete virtualized API, which is responsible for creating testing scenarios by leveraging a virtualization service 210. The concrete virtualized API effectively implements a virtualized API capable of consuming override values. Override values allow testers to customize the payload with specific variables to simulate different conditions. For instance, an override value could specify an item's stock status, enabling scenarios where an item is either in stock or out of stock.

The feature simulation framework also includes a concrete feature executor, which is tasked with implementing and executing specific features. The concrete feature executor interacts with the feature simulation tool to execute these features based on the input values provided in the test cases. In the shopping cart example, the concrete feature executor might handle the “Add to Cart” feature, simulating the addition of an item to the cart and verifying the resultant cart status. Furthermore, the concrete feature executor can invoke an external service 212 to execute test cases that require interaction with external systems or APIs. For example, during the checkout process, the executor might call an external payment gateway to simulate a payment transaction. The external service's response is then incorporated into the test case to validate the feature under test.

The concrete feature executor is designed to produce feature outputs and consume feature inputs, ensuring that each feature operates based on the provided data and produces the expected results. For the shopping cart application, this might involve receiving input values such as item ID, user ID, and payment details, and producing outputs such as confirmation of the item being added to the cart, the total cart value, and successful payment completion. Overall, the feature simulation framework 200 as depicted in FIG. 2 provides a structured approach to simulating and testing software features. By decoupling the features from their live dependencies and virtualizing the testing environment, this framework enables more effective and efficient end-to-end testing. This leads to higher software quality, reduced development time, and the ability to accurately simulate complex interactions within an application, such as those encountered in a shopping cart system.

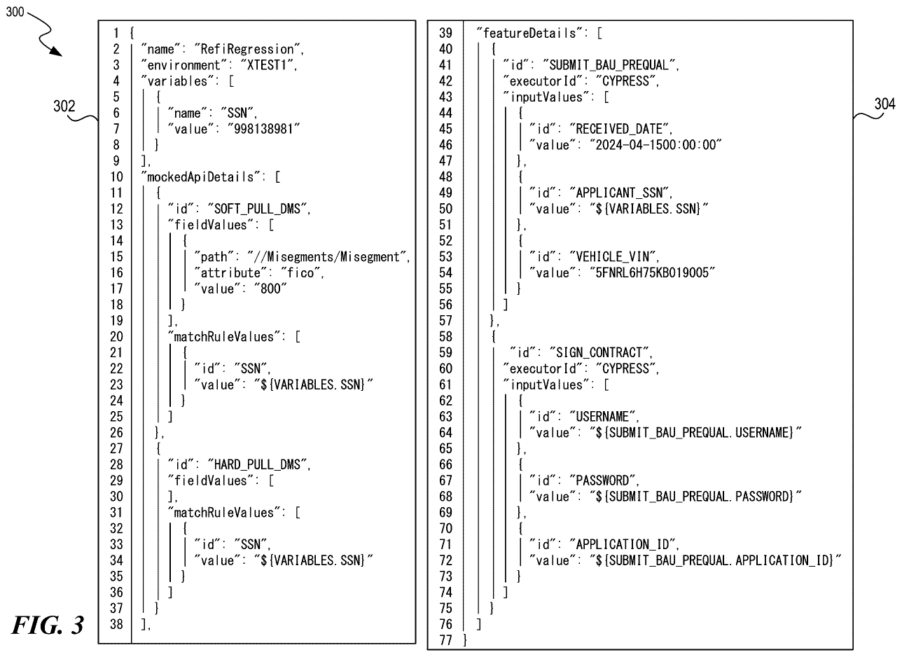

FIG. 3 shows an exemplary simulation request payload 300 for a feature simulation framework in end-to-end testing of software applications, in accordance with one or more implementations. In particular, payload 300 includes mocked API details 302 and feature details 304. The structure and purpose of the simulation request payload is pertinent to the framework for simulating and orchestrating end-to-end testing of software systems. This example payload exemplifies how a request payload body is constructed to facilitate efficient test case execution. The payload is divided into various sections, each containing variables that can be reused multiple times throughout the body, enhancing the flexibility and efficiency of the testing process. The example provided includes common elements such as mocked API details and feature details, which are utilized to update specific paths in the response payload. For instance, an example payload for mocked API details may include fields for different API operations, such as SOFT_PULL_DMS and HARD_PULL_DMS, which define the API operations and specify the necessary parameters. Similarly, an example payload for feature details may include fields for different features, such as SUBMIT_BAU_PREQUAL and SIGN_CONTRACT, which define the features and specify the necessary parameters. This design allows for setting up mock responses and simulating dependencies without the necessity of accessing live systems, thereby optimizing the orchestration of various features under test. The payload's structure ensures that dependencies are accurately represented and managed within the simulation framework, providing a robust mechanism for validating the features and their interdependencies comprehensively.

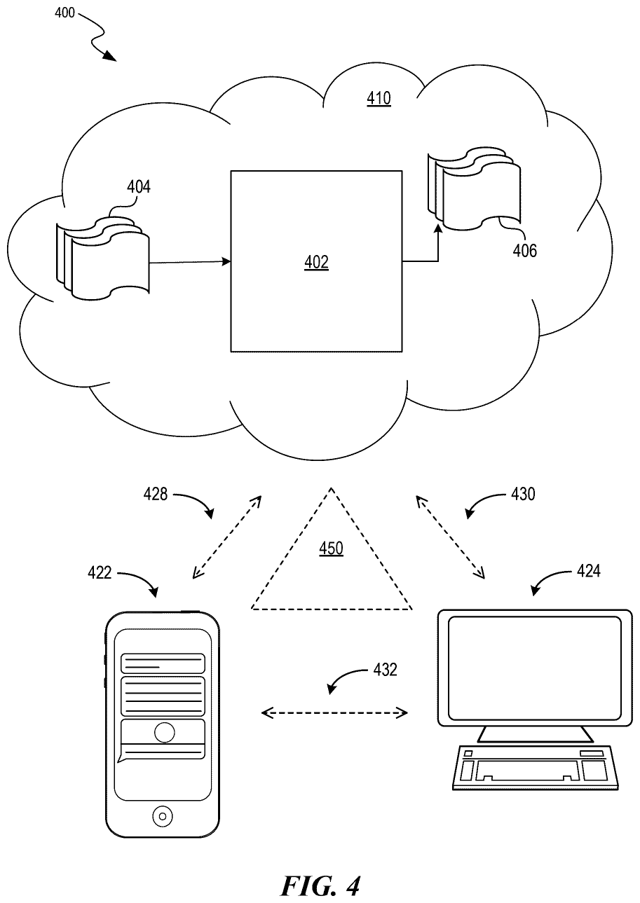

FIG. 4 is an illustrative architecture for a system 400 for implementing a feature simulation framework in end-to-end testing of software applications, in accordance with one or more implementations. As shown in FIG. 4, system 400 may include mobile device 422 and user terminal 424 (either type of device may be a “user device” as referred to herein, though a user device may additionally or alternatively include other types of devices as well). While shown as a smartphone and a personal computer, respectively, in FIG. 4, it should be noted that mobile device 422 and user terminal 424 may be any computing device, including, but not limited to, a laptop computer, a tablet computer, a hand-held computer, or other computer equipment (e.g., a server), including “smart,” wireless, wearable, and/or mobile devices. FIG. 4 also includes cloud components 410. Cloud components 410 may alternatively be any computing device as described above and may include any type of mobile terminal, fixed terminal, or other device. For example, cloud components 410 may be implemented as a cloud computing system and may feature one or more component devices. It should also be noted that system 400 is not limited to three devices. Users may, for instance, utilize one or more devices to interact with one another, one or more servers, or other components of system 400. It should be noted that, while one or more operations are described herein as being performed by particular components of system 400, those operations may, in some implementations, be performed by other components of system 400. As an example, while one or more operations are described herein as being performed by components of mobile device 422, those operations may, in some implementations, be performed by components of cloud components 410. In some implementations, the various computers and systems described herein may include one or more computing devices that are programmed to perform the described functions. Additionally, or alternatively, multiple users may interact with system 400 and/or one or more components of system 400. For example, in one implementation, a first user and a second user may interact with system 400 using two different components.

With respect to the components of mobile device 422, user terminal 424, and cloud components 410, each of these devices may receive content and data via input/output (I/O) paths. Each of these devices may also include processors and/or control circuitry to send and receive commands, requests, and other suitable data using the I/O paths. The control circuitry may comprise any suitable processing, storage, and/or I/O circuitry. Each of these devices may also include a user input interface and/or user output interface (e.g., a display) for use in receiving and displaying data. For example, as shown in FIG. 4, both mobile device 422 and user terminal 424 include a display upon which to display data (e.g., based on output data received from system 400).

Additionally, as mobile device 422 is shown as a touchscreen smartphone, this display also acts as a user input interface. It should be noted that in some implementations, the devices may have neither user input interfaces nor displays and may instead receive and display content using another device (e.g., a dedicated display device such as a computer screen and/or a dedicated input device such as a remote control, mouse, voice input, etc.). Additionally, the devices in system 400 may run an application (or another suitable program). The application may cause the processors and/or control circuitry to perform operations related to generating dynamic database query responses using ensemble prediction by correlating probability models with non-homogenous time dependencies to generate time-specific data processing predictions.

Each of these devices may also include electronic storages. The electronic storages may include non-transitory storage media that electronically stores information. The electronic storage media of the electronic storages may include one or both of (i) system storage that is provided integrally (e.g., is substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 4 also includes communication paths 428, 430, and 432. Communication paths 428, 430, and 432 may include the Internet, a mobile phone network, a mobile voice or data network (e.g., a 5G or LTE network), a cable network, a public switched telephone network, or other types of communication networks or combinations of communication networks. Communication paths 428, 430, and 432 may separately or together include one or more communication paths, such as a satellite path, a fiber-optic path, a cable path, a path that supports Internet communications (e.g., IPTV), free-space connections (e.g., for broadcast or other wireless signals), or any other suitable wired or wireless communication path or combination of such paths. The computing devices may include additional communication paths linking a plurality of hardware, software, and/or firmware components operating together. For example, the computing devices may be implemented by a cloud of computing platforms operating together as the computing devices.

Cloud components 410 may include a server 402 for implementing one or more implementations described with respect to FIGS. 1-5. For example, server 402 may implement a portion or all of the functionality described with respect to FIGS. 1-5. Server 402 may receive input data 404 from mobile device 422, execute the operation to process the input data 404, and transmit output data 406 to user terminal 424. Cloud components 410 may also include control circuitry configured to perform the various operations needed to implement a feature simulation framework in end-to-end testing of software applications, according to one or more implementations.

In some implementations, cloud components 410 include an artificial intelligence model. The artificial intelligence model may take inputs and provide outputs. The inputs may include multiple datasets, such as a training dataset and a test dataset. In some implementations, the outputs may be fed back to the artificial intelligence model as input to train the artificial intelligence model (e.g., alone or in conjunction with user indications of the accuracy of the outputs, with labels associated with the inputs, or with other reference feedback information). For example, the system may receive a first labeled feature input, wherein the first labeled feature input is labeled with a known prediction for the first labeled feature input. The system may then train the artificial intelligence model to classify the first labeled feature input with the known prediction.

In another implementation, the artificial intelligence model may update its configurations (e.g., weights, biases, or other parameters) based on the assessment of its prediction and reference feedback information (e.g., user indication of accuracy, reference labels, or other information). In another implementation, where the artificial intelligence model is a neural network, connection weights may be adjusted to reconcile differences between the neural network's prediction and the reference feedback. In a further use case, one or more neurons (or nodes) of the neural network may require that their respective errors be sent backward through the neural network to facilitate the update process (e.g., backpropagation of error). Updates to the connection weights may, for example, be reflective of the magnitude of error propagated backward after a forward pass has been completed. In this way, for example, the artificial intelligence model may be trained to generate better predictions.

In some implementations, the artificial intelligence model may include an artificial neural network. In such implementations, the artificial intelligence model may include an input layer and one or more hidden layers. Each neural unit of the artificial intelligence model may be connected with many other neural units of the artificial intelligence model. Such connections can be enforcing or inhibitory in their effect on the activation state of connected neural units. In some implementations, each individual neural unit may have a summation function that combines the values of all of its inputs together. In some implementations, each connection (or the neural unit itself) may have a threshold function that the signal must surpass before it propagates to other neural units. The artificial intelligence model may be self-learning and trained, rather than explicitly programmed, and can perform significantly better in certain areas of problem solving as compared to traditional computer programs. During training, an output layer of the artificial intelligence model may correspond to a classification of the artificial intelligence model, and an input known to correspond to that classification may be input into an input layer of the artificial intelligence model during training. During testing, an input without a known classification may be input into the input layer, and a determined classification may be output.

In some implementations, the artificial intelligence model may include multiple layers (e.g., where a signal path traverses from front layers to back layers). In some implementations, backpropagation techniques may be utilized by the artificial intelligence model where forward stimulation is used to reset weights on the “front” neural units. In some implementations, stimulation and inhibition for the artificial intelligence model may be more free flowing, with connections interacting in a more chaotic and complex fashion. During testing, an output layer of the artificial intelligence model may indicate whether or not a given input corresponds to a classification of the artificial intelligence model.

System 400 also includes application programming interface (API) layer 450. API layer 450 may allow the system to communicate across different devices. In some implementations, API layer 450 may be implemented on mobile device 422 or user terminal 424. Alternatively or additionally, API layer 450 may reside on one or more of cloud components 410. API layer 450 (which may be a REST or Web services API layer) may provide a decoupled interface to data and/or functionality of one or more applications. API layer 450 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 450 may use various architectural arrangements. For example, system 400 may be partially based on API layer 450, such that there is strong adoption of SOAP and RESTful Web services, using resources like Service Repository and Developer Portal, but with low governance, standardization, and separation of concerns. Alternatively, system 400 may be fully based on API layer 450, such that separation of concerns between layers like API layer 450, services, and applications are in place.

In some implementations, the system architecture may use a microservice approach. Such systems may use two types of layers: Front-End Layer and Back-End Layer, where microservices reside. In this kind of architecture, the role of the API layer 450 may provide integration between the Front-End Layer and the Back-End Layer. In such cases, API layer 450 may use RESTful APIs (exposition to front-end or event communication between microservices). API layer 450 may use AMQP (e.g., Kafka, RabbitMQ, etc.). API layer 450 may use incipient usage of new communication protocols such as gRPC, Thrift, etc.

In some implementations, the system architecture may use an open API approach. In such cases, API layer 450 may use commercial or open-source API platforms and their modules. API layer 450 may use a developer portal. API layer 450 may use strong security constraints applying WAF and DDoS protection, and API layer 450 may use RESTful APIs as standard for external integration.

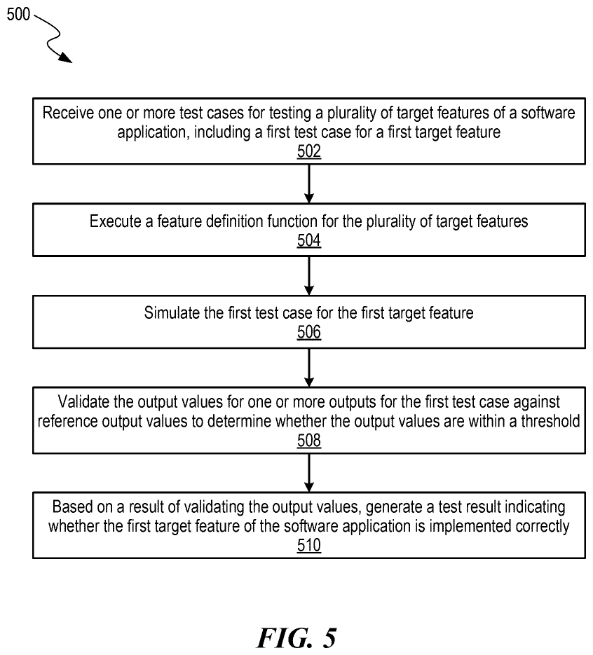

FIG. 5 shows a flowchart of the operations involved in implementing a feature simulation framework in end-to-end testing of software applications, in accordance with one or more implementations. For example, process 500 may represent the operations taken by one or more devices discussed in relation to FIGS. 1-4.

At operation 502, process 500 (e.g., using one or more components in system 400 (FIG. 4)) may receive one or more test cases for testing a plurality of target features of a software application, including a first test case for a first target feature. For example, in a shopping cart application, a test case might involve adding an item to the cart, updating the cart quantity, proceeding to checkout, and making a payment. Each of these actions may represent a target feature within the application.

In some embodiments, the first test case is received via a unified API endpoint configured to facilitate execution of test cases. The unified API endpoint supports configuration of test cases and retrieval of test results. For instance, the REST API 204 in the feature simulation tool 208 can accept a test case that specifies inputs like item ID and quantity, and outputs such as cart status and payment confirmation.

In some embodiments, process 500 may integrate with continuous integration/continuous deployment (CI/CD) pipelines. The unified API endpoint may include hooks and triggers to automatically initiate test cases as part of a software deployment process. For example, during a new release of the shopping cart software, the CI/CD pipeline could automatically trigger the execution of predefined test cases to ensure that new features or bug fixes do not break existing functionalities.

In some embodiments, the first test case is received via a graphical user interface configured to facilitate execution of test cases. The graphical user interface includes tools for visualizing execution flow for test cases and test results. For example, this interface allows testers to design and visualize test cases, such as dragging and dropping components representing features like “Add to Cart” and setting up their dependencies.

At operation 504, process 500 may execute a feature definition function for the plurality of target features. For instance, the system may define features like adding an item to the cart or processing a payment, including the necessary inputs, expected outputs, and associated virtualized APIs.

In some embodiments, a feature definition may be constructed for each target feature, including one or more inputs required for executing the target feature, one or more outputs produced by executing the target feature, and one or more virtualized APIs associated with the target feature. The virtualized APIs may simulate responses of dependency APIs. For example, the “Add to Cart” feature might require inputs like item ID and quantity, produce outputs like confirmation of the item added, and use a virtualized inventory API to check stock levels.

At operation 506, process 500 may simulate the first test case for the first target feature. This may include determining a dependency chain for the first target feature, wherein the dependency chain includes other target features and an execution order. Based on one or more input values from the first test case, the system may invoke one or more external services to execute the first target feature via one or more API calls, simulate one or more user interface interactions, or execute one or more predefined scripts or commands. The system may simulate responses of dependency APIs based on the one or more virtualized APIs associated with the first target feature. The system may simulate other target features in the dependency chain for the first target feature. The system may compile output values for one or more outputs for the first test case. For example, the system may simulate adding an item to the cart by calling the inventory service, followed by proceeding to checkout, invoking a shipping calculation API, and finally, processing a payment through a virtualized payment gateway.

In some embodiments, determining the dependency chain for the first target feature may include generating a feature dependency graph that identifies other target features in the dependency chain and creates a visual representation of the execution order. For example, a graph might show the sequence: “Add to Cart”→“Checkout”→“Payment.”

In some embodiments, process 500 may dynamically adjust the execution order of target features in the dependency chain based on real-time feedback. Dynamically adjusting the execution order may include reordering target features in the dependency chain to optimize test case execution based on current system performance metrics. For instance, if a server handling the checkout feature is experiencing high load, the system might delay executing this feature until load reduces.

In some embodiments, process 500 may simulate network conditions to emulate different network scenarios, including latency, bandwidth limitations, and packet loss, to test feature robustness under varying conditions. For example, it might simulate a weak network connection to ensure the shopping cart application can handle delayed or dropped API responses gracefully.

At operation 508, process 500 may validate the output values for one or more outputs for the first test case against reference output values to determine whether the output values are within a threshold. For example, if the test case specifies that adding an item to the cart should reflect a correct total price, the system may compare the actual price in the cart after the operation against the expected price.

At operation 510, process 500, based on a result of validating the output values, may generate a test result indicating whether the first target feature of the software application is implemented correctly. For example, if the output values match the expected values within acceptable thresholds, the feature is marked as correctly implemented; otherwise, inconsistencies are flagged for review.

In some embodiments, process 500 may capture and store execution traces, including execution logs, API call sequences, input and output values, and execution times, for post-execution analysis. For instance, a log might include timestamps for each step in the sequence of adding an item to the cart, checking out, and processing payment, along with detailed input and output data for each step.

In some embodiments, process 500 may validate responses of dependency APIs against predefined schemas to ensure simulated API responses conform to expected data structures. This ensures that the system's expectations for data format and content are met, reducing the risk of errors during integration.

In some embodiments, process 500, based on receiving an error while simulating the first test case, may execute a rollback mechanism to revert execution to a previous state and continue simulating the first test case from the previous state. For example, if a test case fails during the payment process, the system might roll back to the state just before the payment step and retry the operation or start diagnostics.

In some embodiments, process 500 may provide a test case versioning system. The graphical user interface may include functionality to track changes to test cases, allowing users to revert to previous versions and compare different versions of test cases. This feature is useful for maintaining the integrity of test cases over time and understanding the impact of changes in the application's codebase.

It is contemplated that the operations or descriptions of FIG. 5 may be used with any other implementation of this disclosure. In addition, the operations and descriptions described in relation to FIG. 5 may be done in alternative orders or in parallel to further the purposes of this disclosure. For example, each of these operations may be performed in any order, in parallel, or simultaneously to reduce lag or increase the speed of the system or method. Furthermore, it should be noted that any of the devices or equipment discussed in relation to FIGS. 1-4 could be used to perform one or more of the operations in FIG. 5.

The above-described implementations of the present disclosure are presented for purposes of illustration and not of limitation, and the present disclosure is limited only by the claims that follow. Furthermore, it should be noted that the features and limitations described in any one implementation may be applied to any other implementation herein, and flowcharts or examples relating to one implementation may be combined with any other implementation in a suitable manner, done in different orders, or done in parallel. In addition, the systems and methods described herein may be performed in real time. It should also be noted that the systems and/or methods described above may be applied to, or used in accordance with, other systems and/or methods.

The present techniques for implementing a feature simulation framework in end-to-end testing of software applications will be better understood with reference to the following enumerated implementations:
1. A method for implementing a feature simulation framework in end-to-end testing of software applications, the method comprising: receiving one or more test cases for testing a plurality of target features of a software application, including a first test case for a first target feature; executing a feature definition function for the plurality of target features, wherein a feature definition is constructed for each target feature, including: one or more inputs required for executing the target feature, one or more outputs produced by executing the target feature, and one or more virtualized APIs associated with the target feature, wherein the one or more virtualized APIs simulate responses of dependency APIs; simulating the first test case for the first target feature by: determining a dependency chain for the first target feature, wherein the dependency chain includes other target features from the plurality of target features, wherein the dependency chain specifies an execution order for target features in the dependency chain, wherein output from one target feature is forwarded as input for another target feature; based on one or more input values from the first test case, invoking one or more external services to execute the first target feature via one or more API calls, simulating one or more user interface interactions, and executing one or more predefined scripts or commands; simulating responses of dependency APIs based on the one or more virtualized APIs associated with the first target feature; simulating other target features in the dependency chain for the first target feature; and compiling output values for one or more outputs for the first test case; validating the output values for one or more outputs for the first test case against reference output values to determine whether the output values are within a threshold; and based on a result of validating the output values, generating a test result indicating whether the first target feature of the software application is implemented correctly.
2. A method for implementing a feature simulation framework in end-to-end testing of software applications, the method comprising: receiving a first test case for testing a first target feature of a software application; retrieving a feature definition for the first target feature, including one or more inputs, one or more outputs, and one or more virtualized APIs associated with the first target feature, wherein the one or more virtualized APIs simulate responses of dependency APIs; simulating the first test case for the first target feature by: determining a dependency chain for the first target feature, wherein the dependency chain includes other target features and an execution order; based on one or more input values from the first test case, invoking one or more external services to execute the first target feature via one or more API calls, simulating one or more user interface interactions, or executing one or more predefined scripts or commands; simulating responses of dependency APIs based on the one or more virtualized APIs associated with the first target feature; simulating other target features in the dependency chain for the first target feature; and compiling output values for one or more outputs for the first test case; validating the output values for one or more outputs for the first test case against reference output values to determine whether the output values are within a threshold; and based on a result of validating the output values, generating a test result indicating whether the first target feature of the software application is implemented correctly.
3. A method for implementing a feature simulation framework in end-to-end testing of software applications, the method comprising: receiving a first test case for testing a first target feature of a software application; retrieving a feature definition for the first target feature, including one or more inputs and one or more outputs, and a dependency chain for the first target feature, wherein the dependency chain includes other target features and an execution order; based on one or more input values from the first test case, invoking one or more external services to execute the first target feature; simulating other target features in the dependency chain for the first target feature; and compiling output values for one or more outputs for the first test case for validation against reference output values to determine whether the first target feature of the software application is implemented correctly.
4. The method of any one of the preceding implementations, wherein the first test case is received via a unified API endpoint configured to facilitate execution of test cases, wherein the unified API endpoint supports configuration of test cases and retrieval of test results.
5. The method of any one of the preceding implementations, wherein the first test case is received via a graphical user interface configured to facilitate execution of test cases, wherein the graphical user interface includes tools for visualizing execution flow for test cases and test results.
6. The method of any one of the preceding implementations, wherein determining the dependency chain for the first target feature comprises: generating a feature dependency graph that identifies other target features in the dependency chain and creates a visual representation of the execution order.
7. The method of any one of the preceding implementations, further comprising: dynamically adjusting the execution order of target features in the dependency chain based on real-time feedback, wherein dynamically adjusting the execution order includes reordering target features in the dependency chain to optimize test case execution based on current system performance metrics.
8. The method of any one of the preceding implementations, further comprising: capturing and storing execution traces, including execution logs, API call sequences, input and output values, and execution times, for post-execution analysis.
9. The method of any one of the preceding implementations, further comprising: validating responses of dependency APIs against predefined schemas to ensure simulated API responses conform to expected data structures.
10. The method of any one of the preceding implementations, further comprising: based on receiving an error while simulating the first test case, executing a rollback mechanism to revert execution to a previous state; and continuing simulating the first test case from the previous state.
11. The method of any one of the preceding implementations, further comprising: integrating with continuous integration/continuous deployment (CI/CD) pipelines, wherein the unified API endpoint includes hooks and triggers to automatically initiate test cases as part of a software deployment process.
12. The method of any one of the preceding implementations, further comprising: providing a test case versioning system, wherein the graphical user interface includes functionality to track changes to test cases, allowing users to revert to previous versions and compare different versions of test cases.
13. The method of any one of the preceding implementations, further comprising: simulating network conditions to emulate different network scenarios, including latency, bandwidth limitations, and packet loss, to test feature robustness under varying conditions.
14. One or more non-transitory, computer-readable media storing instructions that, when executed by a data processing apparatus, cause the data processing apparatus to perform operations comprising those of any of implementations 1-13.
15. A system comprising: one or more processors; and memory storing instructions that, when executed by the processors, cause the processors to effectuate operations comprising those of any of implementations 1-13.
16. A system comprising means for performing any of implementations 1-13.

What is claimed is:

1. A system for implementing a feature simulation framework in end-to-end testing of software applications, comprising:
one or more processors; and
one or more non-transitory, computer-readable media comprising instructions that, when executed by the one or more processors, cause operations comprising:
receiving one or more test cases for testing a plurality of target features of a software application, including a first test case for a first target feature;
executing a feature definition function for the plurality of target features, wherein a feature definition is constructed for each target feature, including:
one or more inputs required for executing the target feature,
one or more outputs produced by executing the target feature, and
one or more virtualized APIs associated with the target feature, wherein the one or more virtualized APIs simulate responses of dependency APIs;
simulating the first test case for the first target feature by:
determining a dependency chain for the first target feature, wherein the dependency chain includes other target features from the plurality of target features, wherein the dependency chain specifies an execution order for target features in the dependency chain, wherein output from one target feature is forwarded as input for another target feature;
based on one or more input values from the first test case, invoking one or more external services to execute the first target feature via one or more API calls, simulating one or more user interface interactions, and executing one or more predefined scripts or commands;
simulating responses of dependency APIs based on the one or more virtualized APIs associated with the first target feature;
simulating other target features in the dependency chain for the first target feature; and
compiling output values for one or more outputs for the first test case;
validating the output values for one or more outputs for the first test case against reference output values to determine whether the output values are within a threshold; and
based on a result of validating the output values, generating a test result indicating whether the first target feature of the software application is implemented correctly.

2. A method for implementing a feature simulation framework in end-to-end testing of software applications, comprising:
receiving a first test case for testing a first target feature of a software application;
retrieving a feature definition for the first target feature, including one or more inputs, one or more outputs, and one or more virtualized APIs associated with the first target feature, wherein the one or more virtualized APIs simulate responses of dependency APIs;
simulating the first test case for the first target feature by:
determining a dependency chain for the first target feature, wherein the dependency chain includes other target features and an execution order;
based on one or more input values from the first test case, invoking one or more external services to execute the first target feature via one or more API calls, simulating one or more user interface interactions, or executing one or more predefined scripts or commands;
simulating responses of dependency APIs based on the one or more virtualized APIs associated with the first target feature;
simulating other target features in the dependency chain for the first target feature; and
compiling output values for one or more outputs for the first test case;
validating the output values for one or more outputs for the first test case against reference output values to determine whether the output values are within a threshold; and
based on a result of validating the output values, generating a test result indicating whether the first target feature of the software application is implemented correctly.

3. The method of claim 2, wherein the first test case is received via a unified API endpoint configured to facilitate execution of test cases, wherein the unified API endpoint supports configuration of test cases and retrieval of test results.

4. The method of claim 2, wherein the first test case is received via a graphical user interface configured to facilitate execution of test cases, wherein the graphical user interface includes tools for visualizing execution flow for test cases and test results.

5. The method of claim 2, wherein determining the dependency chain for the first target feature comprises:
generating a feature dependency graph that identifies other target features in the dependency chain and creates a visual representation of the execution order.

6. The method of claim 2, further comprising:
dynamically adjusting the execution order of target features in the dependency chain based on real-time feedback, wherein dynamically adjusting the execution order includes reordering target features in the dependency chain to optimize test case execution based on current system performance metrics.

7. The method of claim 2, further comprising:
capturing and storing execution traces, including execution logs, API call sequences, input and output values, and execution times, for post-execution analysis.

8. The method of claim 2, further comprising:
validating responses of dependency APIs against predefined schemas to ensure simulated API responses conform to expected data structures.

9. The method of claim 2, further comprising:
based on receiving an error while simulating the first test case, executing a rollback mechanism to revert execution to a previous state; and
continuing simulating the first test case from the previous state.

10. The method of claim 3, further comprising:
integrating with continuous integration/continuous deployment (CI/CD) pipelines, wherein the unified API endpoint includes hooks and triggers to automatically initiate test cases as part of a software deployment process.

11. The method of claim 4, further comprising:
providing a test case versioning system, wherein the graphical user interface includes functionality to track changes to test cases, allowing users to revert to previous versions and compare different versions of test cases.

12. The method of claim 2, further comprising:
simulating network conditions to emulate different network scenarios, including latency, bandwidth limitations, and packet loss, to test feature robustness under varying conditions.

13. One or more non-transitory, computer-readable media comprising instructions that, when executed by one or more processors, cause operations comprising:
receiving a first test case for testing a first target feature of a software application;
retrieving a feature definition for the first target feature, including one or more inputs and one or more outputs, and a dependency chain for the first target feature, wherein the dependency chain includes other target features and an execution order;
based on one or more input values from the first test case, invoking one or more external services to execute the first target feature;
simulating other target features in the dependency chain for the first target feature; and
compiling output values for one or more outputs for the first test case for validation against reference output values to determine whether the first target feature of the software application is implemented correctly.

14. The one or more non-transitory, computer-readable media of claim 13, wherein the first test case is received via a unified API endpoint configured to facilitate execution of test cases, wherein the unified API endpoint supports configuration of test cases and retrieval of test results, wherein the unified API endpoint includes hooks and triggers to automatically initiate test cases as part of a software deployment process.

15. The one or more non-transitory, computer-readable media of claim 13, wherein the first test case is received via a graphical user interface configured to facilitate execution of test cases, wherein the graphical user interface includes tools for visualizing execution flow for test cases and test results, wherein the graphical user interface includes functionality to track changes to test cases, allowing users to revert to previous versions and compare different versions of test cases.

16. The one or more non-transitory, computer-readable media of claim 13, wherein the dependency chain for the first target feature is determined by:
generating a feature dependency graph that identifies other target features in the dependency chain and creates a visual representation of the execution order.

17. The one or more non-transitory, computer-readable media of claim 13, further comprising:
dynamically adjusting the execution order of target features in the dependency chain based on real-time feedback, wherein dynamically adjusting the execution order includes reordering target features in the dependency chain to optimize test case execution based on current system performance metrics.

18. The one or more non-transitory, computer-readable media of claim 13, further comprising:
capturing and storing execution traces, including execution logs, API call sequences, input and output values, and execution times, for post-execution analysis.

19. The one or more non-transitory, computer-readable media of claim 13, further comprising:
based on receiving an error while simulating the first test case, executing a rollback mechanism to revert execution to a previous state; and
continuing simulating the first test case from the previous state.

20. The one or more non-transitory, computer-readable media of claim 13, further comprising:
simulating network conditions to emulate different network scenarios, including latency, bandwidth limitations, and packet loss, to test feature robustness under varying conditions.
